(19) United States
(12) Patent Application Publication
(10) Pub. No.: US 2024/0380324 A1
(43) Pub. Date: Nov. 14, 2024

(54) VOLTAGE CONVERTER

(71) Applicant: Murata Manufacturing Co., Ltd., Nagaokakyo-shi (JP)

(72) Inventors: Yoshimitsu USHIMI, Nagaokakyo-shi (JP); Koshi HIMEDA, Nagaokakyo-shi (JP); Nobuyoshi ADACHI, Nagaokakyo-shi (JP); Kenji NISHIYAMA, Nagaokakyo-shi (JP)

(21) Appl. No.: 18/779,985

(22) Filed: Jul. 22, 2024

Related U.S. Application Data
(63) Continuation of application No. PCT/JP2023/017123, filed on May 2, 2023.

(30) Foreign Application Priority Data
Jun. 2, 2022 (JP) 2022-090415

(51) Int. Cl. H02M 3/158

(52) U.S. Cl. CPC H02M 3/158

(57) ABSTRACT

A voltage converter is provided that includes a variable inductor device that is disposed between an input line and an output line, a switching device that is disposed between the input line and the variable inductor device, a capacitor that is disposed between the output line and a ground line and a control circuit configured to switch an inductance value of the variable inductor device and to switch a control mode of the switching device according to a load current in the output line. The control circuit is configured to set the inductance value of the variable inductor device to a first value when the load current is less than a threshold value and set the inductance value of the variable inductor device to a second value that is smaller than the first value when the load current is higher than the threshold value.

### CROSS REFERENCE TO RELATED APPLICATIONS

This application is a continuation of International Application No. PCT/JP2023/017123, filed May 2, 2023, which claims priority to Japanese Patent Application No. 2022-090415, filed Jun. 2, 2022, the entire contents of each of which are hereby incorporated by reference in their entirety.

### TECHNICAL FIELD

The present disclosure relates to a voltage converter including a variable inductor.

### BACKGROUND

An exemplary circuit, such as described in International Publication No. WO2019/188029, described a voltage converter that stores current energy and performs voltage conversion between a voltage of an input line and a voltage of an output line. This voltage converter includes a variable inductor, a variable capacitor, and a controller. The controller changes an inductance value of the variable inductor in accordance with an input/output voltage ratio, which is the ratio between the voltage of the input line and the voltage of the output line. Thus, efficiency of voltage conversion by the voltage converter is improved.

In the voltage converter described in International Publication No. 2019/188029, in order to improve the efficiency of voltage conversion, the inductance value of the variable inductor is changed according to the input/output voltage ratio. Thus, when the input/output voltage ratio is constant (for example, the voltage of the input line is constant at 12 volts and the voltage of the output line is constant at 1 volt), one inductance value is selected regardless of the size of a current (e.g., a load current) flowing in the output line. However, it is difficult to improve the voltage conversion efficiency with the selected one inductance value at both the time when the load current is small (when the load is low) and at the time when the load current is large (when the load is high).

### SUMMARY

In view of the foregoing, the exemplary aspects of the present disclosure provides some techniques to solve the problem mentioned above. Thus, it is an object of the present disclosure to improve voltage conversion efficiency at both the time when a load is low and at the time when the load is high in a voltage converter including a variable inductor.

According to an exemplary aspect of the disclosure, a voltage converter includes a switching device, a variable inductor device and a capacitor that are coupled between an input line and an output line of the voltage converter to convert an input voltage on the input line to an output voltage on the output line. The voltage converter also includes a control circuit configured to provide one or more first control signals to the switching device and provide one or more second control signals to the variable inductor device according to a load current in the output line.

According to another exemplary aspect of the disclosure, a voltage converter includes a variable inductor device that is disposed between an input line and an output line, a switching device that is disposed between the input line and the variable inductor device, a capacitor that is disposed between the output line and a ground line and a control circuit configured to switch an inductance value of the variable inductor device and to switch a control mode of the switching device according to a load current in the output line. The control circuit is configured to set the inductance value of the variable inductor device to a first value when the load current is less than a threshold value and set the inductance value of the variable inductor device to a second value that is smaller than the first value when the load current is higher than the threshold value.

According to another exemplary aspect of the disclosure, a voltage converter is configured to perform conversion of a DC voltage between an input line and an output line. The voltage converter includes a variable inductor device that is disposed between the input line and the output line, a switching device that is disposed between the input line and the variable inductor device, a capacitor that is disposed between the output line and a ground line, and a control circuit that performs switching of an inductance value of the variable inductor device and switching of a control mode for the switching device in accordance with a load current that is a current flowing in the output line.

According to the present disclosure, in a voltage converter including a variable inductor, voltage conversion efficiency is improved appropriately both at the time when a load is low and at the time when the load is high.

### BRIEF DESCRIPTION OF DRAWINGS

FIG. 1 is a diagram illustrating an example of the entire configuration of a voltage converter.

FIG. 2 is a diagram illustrating control modes.

FIG. 3 is a diagram illustrating conduction paths in a variable inductor device.

FIG. 4 is a diagram schematically illustrating the relationship between load current and voltage conversion efficiency.

FIG. 5 is a diagram schematically illustrating the relationship between load current and voltage conversion efficiency.

FIG. 6 is a diagram illustrating control modes.

FIG. 7 is a diagram of an exemplary method of stratification into three load levels.

FIG. 8 is a diagram schematically illustrating the relationship among load current, AC loss, and DC loss.

FIG. 9 is a diagram illustrating an example of the entire configuration of a voltage converter.

FIG. 10 is a diagram illustrating control modes.

FIG. 11 is a diagram illustrating conduction paths in a variable inductor device.

FIG. 12 is a diagram schematically illustrating the relationship between load current and voltage conversion efficiency.

FIG. 13 is a diagram illustrating an example of the entire configuration of a voltage converter.

FIG. 14 is a diagram illustrating control modes.

FIG. 15 is a diagram illustrating conduction paths in a variable inductor device.

FIG. 16 is a diagram illustrating an example of the entire configuration of a voltage converter.

FIG. 17 is a diagram illustrating a configuration example of FETs.

FIG. 18 is a diagram illustrating an example of a cross section of a voltage converter.

FIG. 19 is a diagram illustrating another example of the cross section of the voltage converter.

### DETAILED DESCRIPTION

An exemplary embodiment of the present disclosure will be described in detail below with reference to drawings. In the drawings, the same or equivalent parts are denoted by the same signs and description of those parts will not be provided repeatedly.

### (Entire Configuration of Voltage Converter 1)

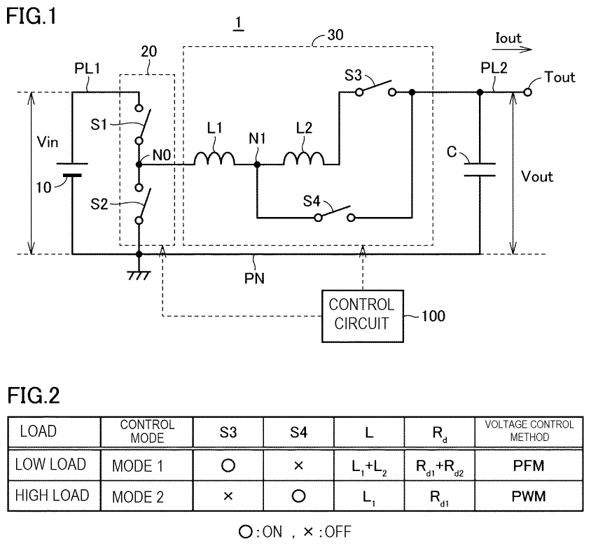

FIG. 1 is a diagram illustrating an example of the entire configuration of a voltage converter 1 according to an exemplary embodiment. The voltage converter 1 includes a DC power supply 10, an input line PL1, an output line PL2, a ground line PN, a switching device (switching regulator) 20, a variable inductor device 30, a capacitor C, and a control circuit 100.

According to the exemplary aspect, the voltage converter 1 is a step-down DC/DC converter that is configured to perform voltage conversion between the voltage of the input line PL1 connected to the DC power supply 10 (the potential difference between the input line PL1 and the ground line PN, hereinafter, also referred to as an “input voltage Vin”) and the voltage of the output line PL2 connected to an output terminal Tout (the potential difference between the output line PL2 and the ground line PN, hereinafter, also referred to as an “output voltage Vout”).

The positive pole of the DC power supply 10 is connected to the input line PL1, and the negative pole of the DC power supply 10 is connected to the ground line PN. Thus, the input voltage Vin is equal to the voltage of the DC power supply 10.

The capacitor C is disposed between the output line PL2 and the ground line PN. The switching device 20 and the variable inductor device 30 are arranged in this order in an area from the input line PL1 to the output line PL2.

The switching device 20 includes two switching elements S1 and S2. The switching elements S1 and S2 are connected in series in this order in an area from the input line PL1 to the ground line PN. The switching elements S1 and S2 are controlled in accordance with an instruction signal from the control circuit 100 and are periodically and complementarily opened and closed (on/off).

The variable inductor device 30 includes two inductors L1 and L2 and two switching elements S3 and S4 (switching unit). The inductors L1 and L2 are connected in series in this order in an area from a connection node NO between the switching elements S1 and S2 of the switching device 20 to the output line PL2.

In operation, the switching elements S3 and S4 are opened and closed (on/off) in accordance with an instruction signal from the control circuit 100. The switching element S3 is disposed between the inductor L2 and the output line PL2. The switching element S4 is disposed between a connection node N1 between the inductors L1 and L2 and the output line PL2.

The switching elements S1 to S4 are, for example, field-effect transistors (FETs) in an exemplary aspect.

The control circuit 100 can include a processor, such as a central processing unit (CPU), memories such as a read only memory (ROM) and a random access memory (RAM), and ports (not illustrated in the drawing) for inputting/outputting various signals. The control circuit 100 performs control of the switching device 20 (control of the switching elements S1 and S2) and switching of the inductance value of the variable inductor device 30 (control of the switching elements S3 and S4) in accordance with a program and a map stored in a memory, signals received from sensors, and the like.

### (Step-Down Operation of Voltage Converter 1)

In an exemplary aspect, the control circuit 100 is configured to control the switching device 20 and the variable inductor device 30 as described below, so that a step-down operation of the voltage converter 1 can be performed.

When the switching element S1 is turned on, the switching element S2 is turned off, and at least one of the switching element S3 and the switching element S4 is turned on, the input voltage Vin causes a load current Iout to flow in the output line PL2. At this time, current energy is stored in an inductor (at least one of the inductors L1 and L2) of the variable inductor device 30. Then, when the switching element S1 is turned off and the switching element S2 is turned on, the inductor of the variable inductor device 30 generates electromotive force for maintaining the load current Iout, and the electromotive force causes the load current Iout to flow via the switching element S2. The inductor of the variable inductor device 30 and the capacitor C configure an LC filter that averages a pulse sequence generated by switching the load current Iout by the switching elements S1 and S2 and outputs the output voltage Vout. The output voltage Vout is stepped down to a desired voltage from the input voltage Vin according to setting of the on-duty ratio of the pulse sequence. As a result, voltage conversion between the input voltage Vin and the output voltage Vout is performed.

### (Loss in Voltage Converter 1)

In a step-down operation of the voltage converter 1, which is a step-down DC/DC converter, due to switching of the switching elements S1 and S2, an AC component is superimposed on the load current Iout. Thus, the load current Iout has a waveform in which an AC component (hereinafter, also referred to as a “ripple current ΔI”) is superimposed on a DC component (hereinafter, also referred to as a “DC current Id”).

Loss in the variable inductor device 30 includes loss caused by the DC current Id, which is a DC component, (hereinafter, also referred to as “DC loss”) and loss caused by the ripple current ΔI, which is an AC component, (hereinafter, also referred to as “AC loss”).

When the load current Iout is small and the load is low, the AC loss caused by the ripple current ΔI is dominant in the loss in the variable inductor device 30. Thus, when the load is low, by reducing the ripple current ΔI, the loss in the variable inductor device 30 can be reduced efficiently.

In general, the larger the inductance value, the smaller the ripple current in the step-down DC/DC converter. Thus, by increasing the inductance value of the variable inductor device 30, the ripple current ΔI is reduced.

In contrast, when the load current Iout is large and the load is high, the DC loss caused by the DC component is dominant in the loss in the variable inductor device 30. Thus, by reducing the resistance of the variable inductor device 30, the loss in the variable inductor device 30 is reduced efficiently.

### (Voltage Control Methods for Switching Device 20)

Voltage control methods for the switching device 20 include a pulse width modulation (PWM) control method and a pulse frequency modulation (PFM) control method.

The PWM control method and the PFM control method are different in aspects of control of a switching frequency, which is a frequency for complementarily opening and closing the switching elements S1 and S2, and a pulse width corresponding to the on-duty ratio of a pulse sequence.

The PWM control method is a control method in which the switching frequency is fixed at a fixed value f0 and the pulse width is changed. The PWM control method has an advantage in that the ripple current ΔI is reduced and the responsiveness with respect to a change in a load is increased, while it has a disadvantage in that, since the switching frequency is fixed at the fixed value f0, switching loss is significant when the load is low.

The PFM control method is a method in which the pulse width is fixed, and the switching frequency is changed within a region lower than the fixed value f0, which is used in the PWM control method. The PFM control method has an advantage in that switching loss can be reduced by setting a low switching frequency when the load is low, while it has a disadvantage in that, since a low switching frequency is set, the ripple current ΔI increases and the responsiveness with respect to a change in the load deteriorates.

### (Control of Voltage Converter 1)

In light of the points described above, the control circuit 100 according to this exemplary embodiment is configured to perform switching of an inductance value L of the variable inductor device 30 and switching of the voltage control method for the switching device 20 in accordance with the load current Iout.

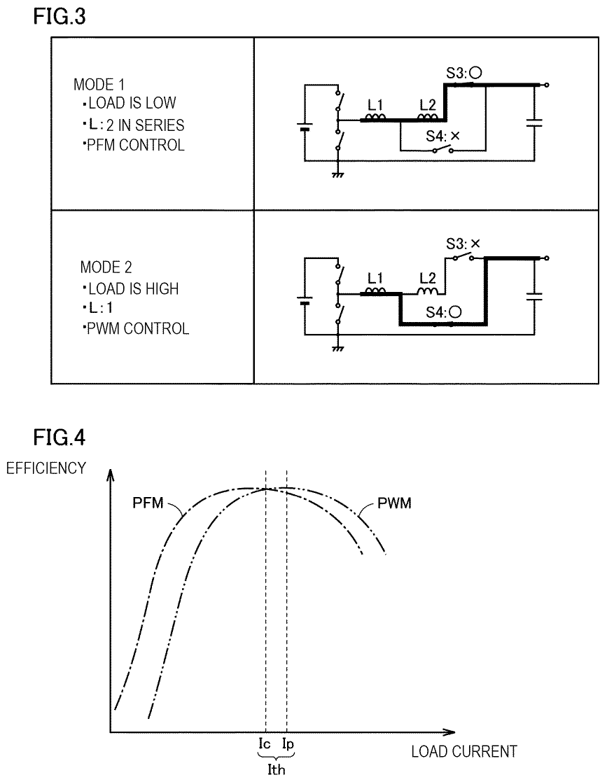

FIG. 2 is a diagram illustrating control modes for the voltage converter 1. FIG. 3 is a diagram illustrating conduction paths in the variable inductor device 30 formed in control modes for the voltage converter 1.

Hereinafter, and for purposes of this disclosure, an inductance value and a DC resistance value of the inductor L1 will also be represented by an “inductance value L1” and a “DC resistance value Rd1”, respectively. Furthermore, an inductance value and a DC resistance value of the inductor L2 will also be represented by an “inductance value L2” and a “DC resistance value Rd2”, respectively. The inductance value L1 and the inductance value L2 may be the same or may be different. Similarly, the DC resistance value Rd1 and the DC resistance value Rd2 may be the same or may be different.

As illustrated in FIG. 2, the control circuit 100 sets the control mode for the voltage converter 1 to “mode 1” when the load is low and sets the control mode for the voltage converter 1 to “mode 2” when the load is high.

In the “mode 1” at the time when the load is low, the switching element S3 of the variable inductor device 30 is in an ON state and the switching element S4 is in an OFF state. Thus, as illustrated in FIG. 3, the two inductors L1 and L2 in the variable inductor device 30 are connected in series to the output line PL2. Therefore, the inductance value L of the variable inductor device 30 is the sum of the inductance value L1 and the inductance value L2 (=L1+L2). Furthermore, the DC resistance value Rd of the variable inductor device 30 is the sum of the DC resistance value Rd1 and the DC resistance value Rd2 (=Rd1+Rd2).

Furthermore, in the “mode 1”, the voltage control method for the switching device 20 is set to the PFM control method.

In contrast, in the “mode 2” at the time when the load is high, the switching element S3 of the variable inductor device 30 is in the OFF state and the switching element S4 is in the ON state. Thus, as illustrated in FIG. 3, only the inductor L1 in the variable inductor device 30 is connected to the output line PL2. Therefore, the inductance value L and the DC resistance value Rd of the variable inductor device 30 are the inductance value L1 and the DC resistance value Rd1, respectively.

Furthermore, in the “mode 2”, the voltage control method for the switching device 20 is set to the PWM control method.

According to the exemplary aspect, the determination as to whether the load is low or the load is high can be performed by, for example, comparing the load current Iout with a threshold value Ith. That is, the control circuit 100 can be configured to determine that the load is low when the load current Iout is less than the threshold value Ith and can further be configured to determine that the load is high when the load current Iout is not less than the threshold value Ith. The threshold value Ith that is compared with the load current Iout can be set in advance by taking into consideration efficiency at the time of PFM control and efficiency at the time of PWM control and can be stored in a memory.

FIG. 4 is a diagram schematically illustrating the relationship between load current and voltage conversion efficiency at the time of PFM control and at the time of PWM control. As illustrated in FIG. 4, the efficiency at the time of PFM control and the efficiency at the time of PWM control reach their peaks when the load current reaches certain values, and the value of the load current at the time of the peak efficiency of PFM control is less than or equal to the value of the load current at the time of the peak efficiency of PWM control (hereinafter, also referred to as a “peak current value Ip”). Therefore, the efficiency at the time of PFM control and the efficiency at the time of PWM control cross at the time when the load current is at a predetermined value (hereinafter, also referred to as a “cross current Ic”). In a region in which the load current is smaller than the cross current Ic, the efficiency at the time of PFM control is higher than the efficiency at the time of PWM control. In a region in which the load current is larger than the cross current Ic, the efficiency at the time of PWM control is higher than the efficiency at the time of PFM control.

In light of the points described above, the threshold value Ith may be set to the cross current Ic. Furthermore, since the value of the peak current Ip is close to the value of the cross current Ic, the threshold value Ith may be set to the peak current Ip. Alternatively, the threshold value Ith may be set to a value within the range from the cross current Ic to the peak current Ip.

As described above, when the load is low, the control circuit 100 according to this exemplary embodiment sets the voltage control method for the switching device 20 to the PFM control method and sets a low switching frequency, so that switching loss in the switching device 20 is reduced. Furthermore, when the load is low, the control circuit 100 connects the two inductors L1 and L2 in the variable inductor device 30 in series and increases the inductance value L, so that the ripple current ΔI is reduced. Thus, AC loss caused by the ripple current ΔI, which is dominant when the load is low, is reduced.

In contrast, when the load is high, the control circuit 100 sets the voltage control method for the switching device 20 to the PWM control method and sets the number of inductors in the variable inductor device 30 to one, so that the DC resistance value Rd of the variable inductor device 30 is reduced. Thus, DC loss caused by the DC current Id, which is dominant when the load is high, is reduced.

As a result of the above, in the voltage converter 1 including the variable inductor device 30, voltage conversion efficiency is improved appropriately both at the time when the load is low and at the time when the load is high.

FIG. 5 is a diagram schematically illustrating the relationship between load current and voltage conversion efficiency in the case where control in this exemplary embodiment is performed. As illustrated in FIG. 5, both at the time when the load is low and at the time when the load is high, the efficiency of control in this exemplary embodiment is higher than the efficiency at the time of PWM control and the efficiency at the time of PFM control.

In addition to reducing the switching loss in the PFM control, reducing the AC loss, which is dominant when the load is low, by increasing the inductance value L of the variable inductor device 30 contributes to the fact that the efficiency of control in this exemplary embodiment is higher than the efficiency at the time of PFM control when the load is low.

Furthermore, in addition to reducing the AC loss in the PWM control method, reducing the DC loss, which is dominant when the load is high, by setting the number of inductors in the variable inductor device 30 to one to reduce the DC resistance value Rd contributes to the fact that the efficiency of the control in this exemplary embodiment is higher than the efficiency at the time of PWM control when the load is high.

In this exemplary embodiment, the size relationship between the inductance value L1 and the inductance value L2 is not mentioned. However, for example, in a system that places more importance on efficiency at the time when the load is high, the inductance value L1 may be proactively set to be smaller than the inductance value L2.

### [Modification 1]

In the exemplary embodiment described above, since switching of the inductance value L and switching of the voltage control method are performed at the same time, control can be performed easily.

However, the timing of switching of the inductance value L and the timing of switching of the voltage control method may be different.

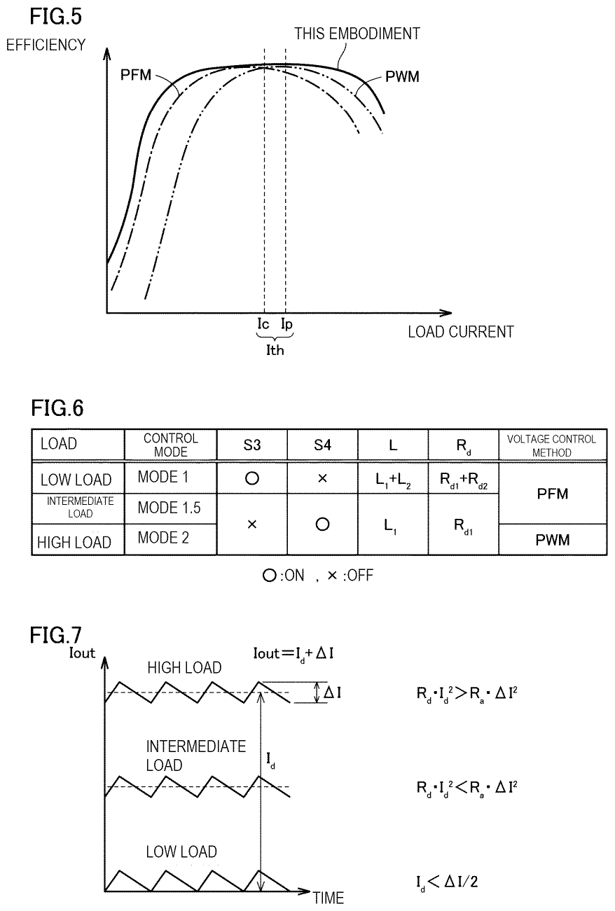

FIG. 6 is a diagram illustrating control modes in Modification 1. As illustrated in FIG. 6, in Modification 1, load is stratified into three levels: low load, intermediate load, and high load. “Mode 1”, “mode 1.5”, and “mode 2” are set for the low load, the intermediate load, and the high load, respectively.

The “mode 1” at the time when the load is low and the “mode 2” at the time when the load is high are the same as the control modes described above and illustrated in FIG. 2. In the “mode 1.5” with the intermediate load, the voltage control method is maintained to be the PFM control method as in the mode 1 and the state of the switching elements S3 and S4 are switched to the same state as that in the mode 2. Thus, for example, in the case where the load changes in the order of low load, intermediate load, and high load, the inductance value L is switched at the timing when the load is switched from the low load to the intermediate load, and then the voltage control method is switched at the timing when the load is switched from the intermediate load to the high load.

FIG. 7 is a diagram for explaining an example of a method of stratification into three load levels (low load, intermediate load, and high load) in Modification 1. In FIG. 7, the horizontal axis represents time, and the vertical axis represents the load current Iout.

The load current Iout has a waveform in which the ripple current ΔI, which is an AC component, is superimposed on the DC current Id, which is a DC component.

Thus, in the case where the DC current Id is less than half the ripple current ΔI(Id<ΔI/2), a zero cross state in which positive and negative of the load current Iout are switched due to the ripple current ΔI is entered. This state is determined to be a low load.

In contrast, in the case where the DC current Id is more than half the ripple current ΔI(Id>ΔI/2), stratification into intermediate load and high load is performed based on the size relationship between AC loss and DC loss.

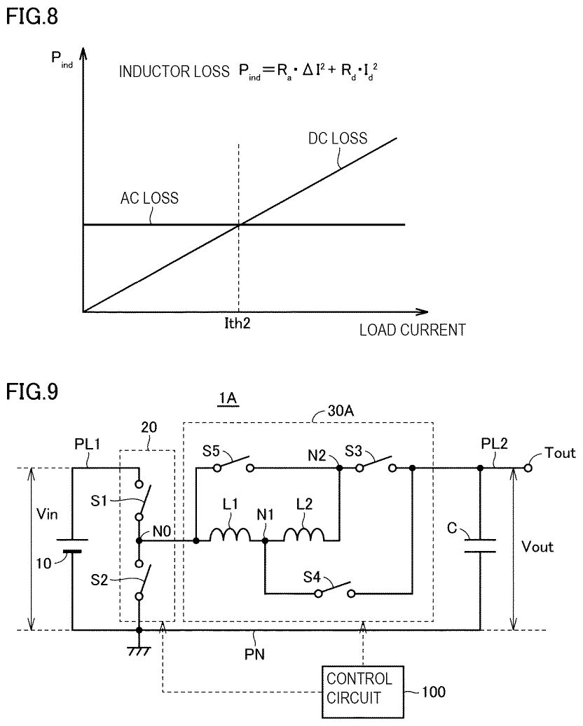

FIG. 8 is a diagram schematically illustrating the relationship among load current, AC loss, and DC loss.

The AC loss is fixed even if the load current varies; whereas, the DC loss increases in proportion to the load current.

Loss Pind in an inductor of the variable inductor device 30 is the sum of the AC loss and the DC loss. As is clear from FIG. 8, the AC loss is dominant (the AC loss is larger than the DC loss) in a region in which the value of the load current is smaller than that at the intersection between the AC loss and the DC loss; whereas, the DC loss is dominant (the DC loss is larger than the AC loss) in a region in which the value of the load current is larger than that at the intersection between the AC loss and the DC loss.

The AC loss is represented by the product of an AC resistance value Ra of the inductor in the variable inductor device 30 and a square value of the ripple current ΔI (=Ra·ΔI2). In contrast, the DC loss is represented by the product of the DC resistance value Rd of the inductor in the variable inductor device 30 and a square value of the DC current Id (=Rd·Id2)).

Thus, as illustrated in FIG. 7, the control circuit 100 determines that the load is an intermediate load in the case where the relationship Rd·Id2<Ra·ΔI2 is obtained and determines that the load is a high load in the case where the relationship Rd·Id2>Ra·ΔI2 is obtained.

With the modification described above, the timing of switching of the inductance value L and the timing of switching of the voltage control method may be made different.

Furthermore, switching of the voltage control method may be performed first according to the load current without setting in advance the inductance value L corresponding to the load current. After that, the determination as to which inductance value L is efficient may be performed, and switching of the inductance value L may be performed so that the inductance value determined to be efficient can be set.

### [Modification 2]

FIG. 9 is a diagram illustrating an example of the entire configuration of a voltage converter 1A according to Modification 2. The voltage converter 1A is obtained by replacing the variable inductor device 30 of the voltage converter 1 described above and illustrated in FIG. 1 by a variable inductor device 30A. The variable inductor device 30A is obtained by adding a switching element S5 to the variable inductor device 30.

The switching element S5 is disposed between the connection node NO between the switching elements S1 and S2 in the switching device 20 and a connection node N2 between the inductor L2 and the switching element S3. The switching element S5 is opened and closed (on/off) in accordance with an instruction signal from the control circuit 100.

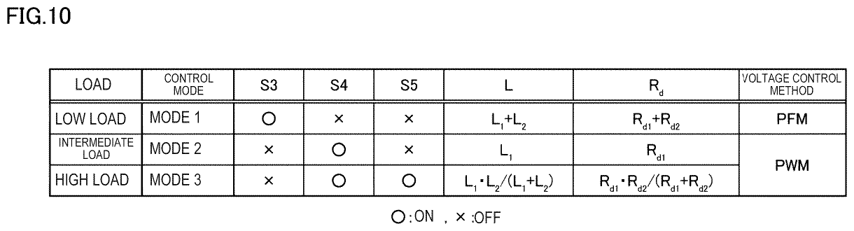

FIG. 10 is a diagram illustrating control modes in Modification 2. FIG. 11 is a diagram illustrating conduction paths in the variable inductor device 30A formed in control modes in Modification 2.

As illustrated in FIG. 10, in Modification 2, load is stratified into three levels: low load, intermediate load, and high load, as in Modification 1 described above. “Mode 1”, “mode 2”, and “mode 3” are set for the low load, the intermediate load, and the high load, respectively.

In the “mode 1” at the time when the load low and in the “mode 2” at the time when the load is intermediate, the switching element S5 is in the OFF state. Thus, the “mode 1” and the “mode 2” are substantially the same as the mode 1 and the mode 2 described above and illustrated in FIG. 2.

In the “mode 3” with a high load, the switching element S5 is turned on, unlike in the “mode 2” at the time when the load is intermediate. Thus, as illustrated in FIG. 11, the two inductors L1 and L2 in the variable inductor device 30 are connected in parallel to the output line PL2. Therefore, the inductance value L in the mode 3 is represented by L1·L2/(L1+L2) and is smaller than the inductance value L=L1 in the mode 2. Furthermore, the DC resistance value Rd in the mode 3 is represented by Rd1·Rd2/(Rd1+Rd2) and is smaller than the DC resistance value Rd=Rd1 in the mode 2.

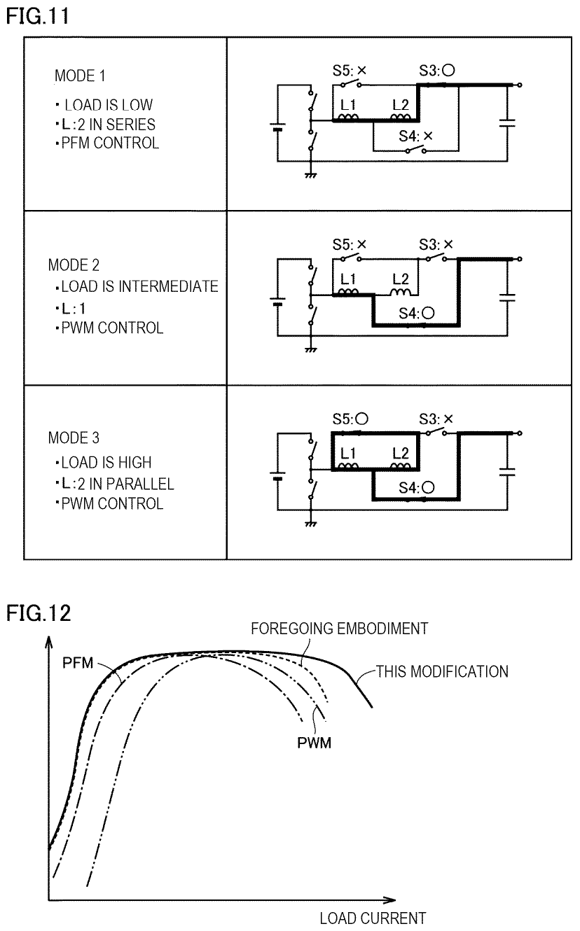

FIG. 12 is a diagram schematically illustrating the relationship between load current and voltage conversion efficiency in the case where control in Modification 2 is performed. In Modification 2, the “mode 3” in which the inductance value L and the DC resistance value Rd are smaller than those in the mode 2 is set when the load is high. Thus, efficiency at the time when the load is high is further improved compared to that in the exemplary embodiment described above.

As described above, when the load is low, the control circuit 100 in Modification 2 can reduce the switching loss by using the PFM control method and setting the switching frequency to a low value and can reduce the AC loss caused by the ripple current ΔI by connecting the inductors L1 and L2 in series to increase the inductance value L.

Furthermore, when the load is intermediate, the control circuit 100 can reduce the DC loss by performing switching to the PWM control method and connecting only the inductor L1 to reduce the DC resistance value Rd.

Moreover, when the load is high, the control circuit 100 can further reduce the DC loss by using the PWM control method and connecting the inductors L1 and L2 in parallel to further reduce the DC resistance value Rd.

In the case where the load current is rapidly increased or other cases, droop (voltage variation) in the output voltage Vout may occur. In such a case, by connecting the inductors L1 and L2 in parallel and reducing the inductance value L, a rapid response and a stable output voltage Vout is achieved.

### [Modification 3]

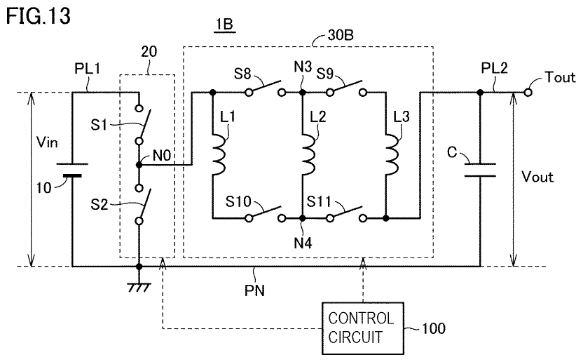

FIG. 13 is a diagram illustrating an example of the entire configuration of a voltage converter 1B according to Modification 3. The voltage converter 1B is obtained by replacing the variable inductor device 30 in the voltage converter 1 described above and illustrated in FIG. 1 by a variable inductor device 30B.

The variable inductor device 30B includes three inductors L1 to L3 and four switching elements S8 to S11 (switching unit).

The switching element S8, the switching element S9, and the inductor L3 are connected in series in this order in an area from the connection node NO to the output line PL2. The inductor L1, the switching element S10, and the switching element S11 are connected in series in this order in an area from the connection node NO to the output line PL2. The inductor L2 is connected between a connection node N3 between the switching elements S8 and S9 and a connection node N4 between the switching elements S10 and S11. The switching elements S8 to S11 are opened and closed (on/off) in accordance with an instruction signal from the control circuit 100.

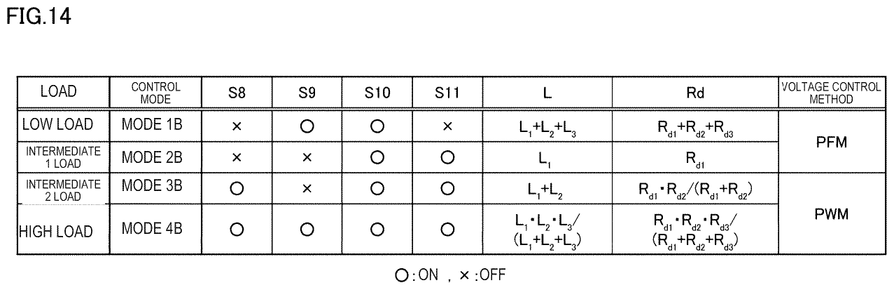

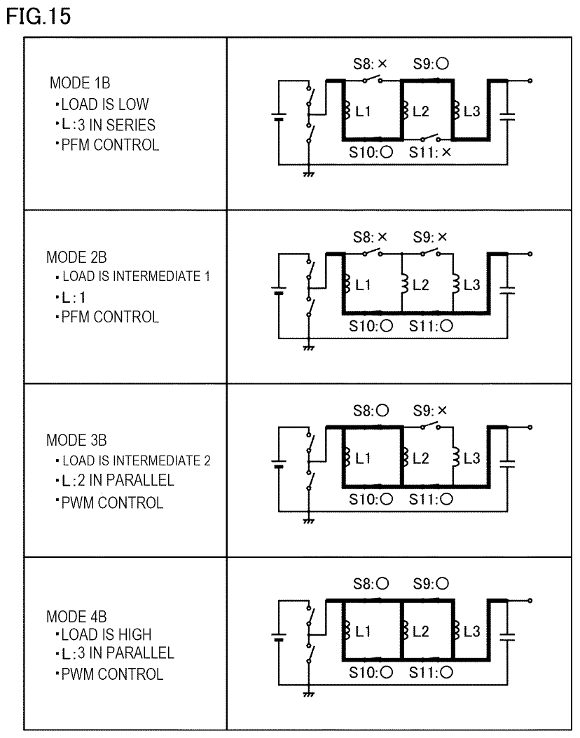

FIG. 14 is a diagram illustrating control modes in Modification 3. FIG. 15 is a diagram illustrating conduction paths in the variable inductor device 30B formed in control modes in Modification 3.

As illustrated in FIG. 14, in Modification 3, load is stratified into four levels: low load, intermediate 1 load, intermediate 2 load, and high load, and “mode 1B”, “mode 2B”, “mode 3B”, and “mode 4B” are set for the low load, the intermediate 1 load, the intermediate 2 load, and the high load, respectively.

In the “mode 1B” and the “mode 2B”, the voltage control method is set to the PFM control method. In the “mode 3B” and the “mode 4B”, the voltage control method is set to the PWM control method.

Furthermore, in the “mode 1B”, the switching elements S9 and S10 are turned on and the switching elements S8 and S11 are turned off. Thus, as illustrated in FIG. 15, the three inductors L1 to L3 are connected in series to the output line PL2. Therefore, the inductance value L is represented by L1+L2+L3, and the DC resistance value Rd is represented by Rd1+Rd2+Rd3.

In the “mode 2B”, the switching elements S10 and S11 are turned on and the switching elements S8 and S9 are turned off. Thus, as illustrated in FIG. 15, only the inductor L1 is connected to the output line PL2. Therefore, the inductance value L is represented by L1 and the DC resistance value Rd is represented by Rd1.

In the “mode 3B”, the switching elements S8, S10, and S11 are turned on, and the switching element S9 is turned off. Thus, as illustrated in FIG. 15, the two inductors L1 and L2 are connected in parallel to the output line PL2. Therefore, the inductance value L is represented by L1·L2/(L1+L2), and the DC resistance value Rd is represented by Rd1·Rd2/(Rd1+Rd2).

In the “mode 4B”, the switching elements S8 to S11 are turned on. Thus, as illustrated in FIG. 15, the three inductors L1 to L3 are connected in parallel to the output line PL2. Therefore, the inductance value L is represented by L1·L2·L3/(L1+L2+L3), and the DC resistance value Rd is represented by Rd1·Rd2·Rd3/(Rd1+Rd2+Rd3).

As in Modification 4, the load can be stratified into four levels, and four modes: mode 1B, mode 2B, mode 3B, and mode 4B, may be set for the individual load levels.

### [Modification 4]

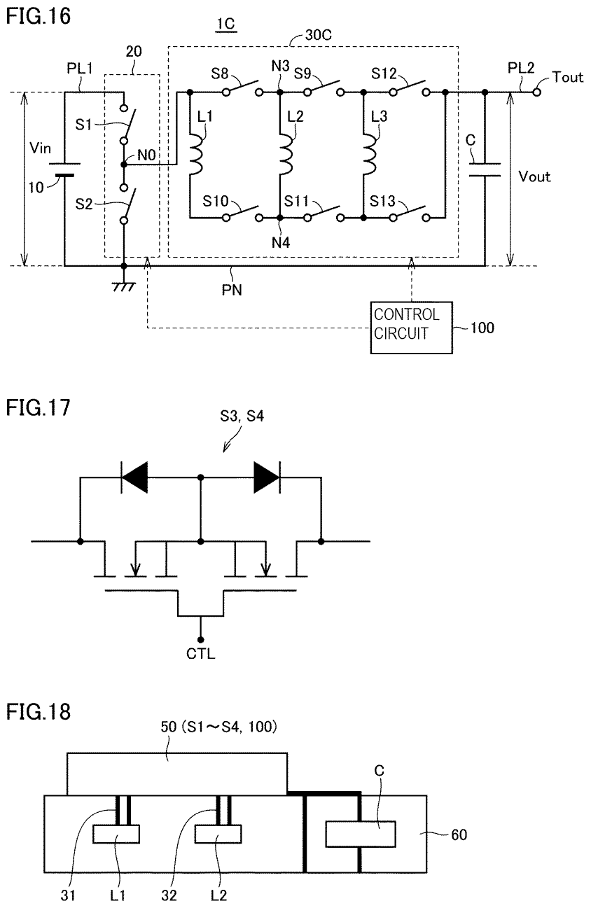

FIG. 16 is a diagram illustrating an example of the entire configuration of a voltage converter 1C according to Modification 4. The voltage converter 1C is obtained by replacing the variable inductor device 30B in the voltage converter 1B according to Modification 3 described above by a variable inductor device 30C.

The variable inductor device 30C is obtained by adding switching elements S12 and S13 (switching unit) to the variable inductor device 30B according to Modification 3 described above.

With the modification described above, the combination of the inductance value L and the DC resistance value Rd is changed more finely.

### [Modification 5]

The switching elements S1 to S4 in the voltage converter 1 described above may be so-called back-to-back connected FETs.

FIG. 17 is a diagram illustrating a configuration example of FETs in which the switching elements S3 and S4 in the variable inductor device 30 are back-to-back connected. With the switching elements S3 and S4 in the variable inductor device 30 configured as illustrated in FIG. 17, backflow to an FET is prevented, and a stable operation of the voltage converter 1 is achieved.

### [Modification 6]

Out of the component elements of the voltage converter 1 described above, the switching elements S1 to S4 and the control circuit 100 may be mounted on a mounting substrate and the inductors L1 and L2 may be built inside the mounting substrate according to an exemplary aspect.

FIG. 18 is a diagram illustrating an example of a cross section of the voltage converter 1 according to Modification 6. In the example illustrated in FIG. 18, out of the component elements of the voltage converter 1, a substrate 50 including the switching elements S1 to S4 and the control circuit 100 is mounted on a mounting substrate 60, and the inductors L1 and L2 and the capacitor C are built inside the mounting substrate 60.

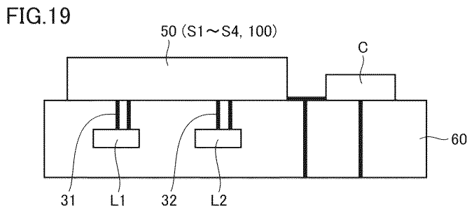

FIG. 19 is a diagram illustrating another example of the cross section of the voltage converter 1 according to Modification 6. In the example illustrated in FIG. 19, the capacitor C is mounted on the mounting substrate 60 not built inside the mounting substrate 60, unlike the example illustrated in FIG. 18.

In both exemplary aspects, the inductors L1 and L2 are built inside the mounting substrate 60 on which the switching elements S1 to S4 are mounted. Thus, the lengths of wires 31 and 32 between the switching elements S1 to S4 and the inductors L1 and L2 can be shortened. As a result, the phase difference between the inductors L1 and L2 in the situation in which the inductors L1 and L2 are connected in parallel is reduced.

The exemplary embodiment and modifications thereof disclosed herein are to be considered in all respects to be illustrative and not restrictive.

It is also noted that the foregoing exemplary embodiment and modifications thereof are concrete examples of aspects described below.

Some exemplary aspects of the disclosure provide a voltage converter that is configured to perform conversion of DC voltage between an input line and an output line. The voltage converter includes a variable inductor device that is disposed between the input line and the output line, a switching device that is disposed between the input line and the variable inductor, a capacitor that is disposed between the output line and a ground line, and a control circuit that performs switching of an inductance value of the variable inductor device and switching of a control mode for the switching device in accordance with a load current that is a current flowing in the output line. The control circuit can be configured to set the inductance value of the variable inductor device to a first value when the load current is less than a threshold value and to set the inductance value of the variable inductor device to a value smaller than the first value when the load current is more than the threshold value.

In some exemplary embodiments, the control circuit is configured to perform switching of the control mode for the switching device at a timing when the inductance value of the variable inductor device is changed.

In some exemplary embodiments, the variable inductor device includes a plurality of inductors, and a switching unit that is configured to be opened and closed in accordance with a signal from the control circuit and switches which one of the plurality of inductors is to be connected in series between the switching device and the output line.

In some exemplary embodiments, the variable inductor device includes a plurality of inductors, and a switching unit that is configured to be opened and closed in accordance with a signal from the control circuit and switches whether a connection aspect of the plurality of inductors between the switching device and the output line is to be series connection or parallel connection.

In some exemplary embodiments, the plurality of inductors are built inside a substrate on which the switching unit is mounted.

In some exemplary embodiments, the switching unit includes back-to-back connected field effect transistors.

In some exemplary embodiments, the control circuit is configured to set the control mode for the switching device to a pulse frequency modulation control mode when the load current is less than the threshold value and to set the control mode to a pulse width modulation control mode when the load current is more than the threshold value.

In some exemplary embodiments, the control circuit is configured to perform switching of the control mode for the switching device in accordance with the load current, after switching of the control mode for the switching device is performed, determine which inductance value is efficient, and switch the inductance value of the variable inductor device to an inductance value that has been determined to be efficient.

### REFERENCE SIGNS LIST

1, 1A, 1B, 1C voltage converter, 10 DC power supply, 20 switching device, 30, 30A, 30B, 30C variable inductor device, 31, 32 wire, 50 substrate, 60 mounting substrate, 100 control circuit, C capacitor, L1, L2, L3 inductor, NO to N4 connection node, PL1 input line, PL2 output line, PN ground line, Tout output terminal.

What is claimed is:

1. A voltage converter comprising:
a variable inductor device disposed between an input line and an output line;
a switching device disposed between the input line and the variable inductor device;
a capacitor is disposed between the output line and a ground line; and
a control circuit configured to switch an inductance value of the variable inductor device and to switch a control mode of the switching device according to a load current in the output line,
wherein the control circuit is further configured to set the inductance value of the variable inductor device to a first value when the load current is less than a threshold value and to set the inductance value of the variable inductor device to a second value that is smaller than the first value when the load current is higher than the threshold value.

2. The voltage converter according to claim 1, wherein the control circuit is further configured to switch the control mode for the switching device when the inductance value of the variable inductor device is changed.

3. The voltage converter according to claim 1, wherein the variable inductor device includes:
a plurality of inductors; and
a switching unit that is configured to be opened and closed according to a signal from the control circuit and couples at least one of the plurality of inductors between the switching device and the output line.

4. The voltage converter according to claim 1, wherein the variable inductor device includes:
a plurality of inductors, and
a switching unit that is configured to be opened and closed according to a signal from the control circuit and changes a connection configuration of the plurality of inductors to be a series connection or a parallel connection.

5. The voltage converter according to claim 3, wherein the variable inductor device includes the plurality of inductors that are built inside a substrate on which the switching unit is mounted.

6. The voltage converter according to claim 3, wherein the switching unit includes back-to-back connected field effect transistors.

7. The voltage converter according to claim 1, wherein the control circuit is configured to set the control mode for the switching device to a pulse frequency modulation (PFM) control mode when the load current is less than the threshold value and set the control mode to a pulse width modulation (PWM) control mode when the load current is more than the threshold value.

8. The voltage converter according to claim 1, wherein the control circuit is configured to:
perform a switching of the control mode for the switching device according to the load current;
after the switching of the control mode for the switching device, determine a specific inductance value that increases an efficiency of the voltage converter; and
switch the inductance value of the variable inductor device to the specific inductance value.

9. The voltage converter according to claim 1, wherein the control circuit is configured to:
determine a load level of the voltage converter from a low load, an intermediate load, and a high load based on the load current in the output line, and
control the voltage converter in a first mode when the load level is the low load, control the voltage converter in a second mode when the load level is the high load, and control the voltage converter in an intermediate mode when the load level is the intermediate load,
wherein the switching device is controlled by a pulse frequency modulation (PFM) control method in the first mode and the intermediate mode, and controlled by a pulse width modulation (PWM) control method in the second mode,
wherein the inductance value of the variable inductor device is the first value in the first mode and the second value that is smaller than the first value in the second mode and the intermediate mode.

10. A voltage converter comprising:
a switching device, a variable inductor device and a capacitor that are coupled between an input line and an output line of the voltage converter to convert an input voltage on the input line to an output voltage on the output line; and
a control circuit configured to provide one or more first control signals to the switching device, and one or more second control signals to the variable inductor device according to a load current in the output line.

11. The voltage converter according to claim 10, wherein the control circuit is configured to generate the one or more first control signals that control the switching device using one of a pulse frequency modulation (PFM) control method and a pulse width modulation (PWM) control method.

12. The voltage converter according to claim 11, wherein the control circuit is configured to generate the one or more first control signals that control the switching device using the PFM control method when the load current is lower than a threshold, and to generate the one or more first control signals that control the switching device using the PWM control signals when the load current is higher than the threshold.

13. The voltage converter according to claim 10, wherein the control circuit is further configured to generate the one or more second control signals that control the variable inductor device to have a first inductance value when the load current is less than a threshold value, and to have a second inductance smaller than the first inductance value when the load current is higher than the threshold value.

14. The voltage converter according to claim 13,
wherein the control circuit is further configured to generate the one or more first control signals and the one or more second control signals to control the voltage converter in a first mode when the load current is lower than a threshold value, and to control the voltage converter in a second mode when the load current is higher than the threshold value,
wherein the switching device is controlled by a pulse frequency modulation (PFM) control method in the first mode, and controlled by a pulse width modulation (PWM) control method in the second mode, and
wherein the variable inductor device has a first inductance value in the first mode and has a second inductance value that is smaller than the first inductance value in the second mode.

15. The voltage converter according to claim 10, wherein the variable inductor device includes:
a plurality of inductors; and
a switching unit that is controlled according to the one or more second control signals from the control circuit and couples at least one of the plurality of inductors between the switching device and the output line.

16. The voltage converter according to claim 10, wherein the variable inductor device includes:
a plurality of inductors, and
a switching unit that is controlled by the one or more second control signals and changes a connection configuration of the plurality of inductors to be a series connection or a parallel connection.

17. The voltage converter according to claim 15, wherein the variable inductor device includes the plurality of inductors that are built inside a substrate on which the switching unit is mounted.

18. The voltage converter according to claim 15, wherein the switching unit includes back-to-back connected field effect transistors.

19. The voltage converter according to claim 10, wherein the control circuit is further configured to:
determine the one or more first control signals to switch a control mode for the switching device according to the load current;
after the control mode for the switching device is switched, determine a specific inductance value that increases an efficiency of the voltage converter; and
change an inductance value of the variable inductor device to the specific inductance value.

20. The voltage converter according to claim 10, wherein the control circuit is configured to:
determine a load level of the voltage converter from a low load, an intermediate load, and a high load based on the load current in the output line, and
control the voltage converter in a first mode when the load level is the low load, control the voltage converter in a second mode when the load level is the high load, and control the voltage converter in an intermediate mode when the load level is the intermediate load,
wherein the switching device is controlled by a pulse frequency modulation (PFM) control method in the first mode and the intermediate mode, and controlled by a pulse width modulation (PWM) control method in the second mode,
wherein the inductance value of the variable inductor device is the first value in the first mode and the second value that is smaller than the first value in the second mode and the intermediate mode.
